(19) United States
(12) Patent Application Publication
(10) Pub. No.: US 2009/0130436 A1
(43) Pub. Date: May 21, 2009

(54) Spray coating member having excellent heat emmision property and so on and method for producing the same

(76) Inventors: Yoshio Harada, Hyogo (JP); Junichi Takeuchi, Hyogo (JP); Ryo Yamasaki, Hyogo (JP); Keigo Kobayashi, Chiba (JP)

Correspondence Address: GREENBLUM & BERNSTEIN, P.L.C., 1950 ROLAND CLARKE PLACE, RESTON, VA, 20191, US

(21) Appl. No.: 11/990,755

(22) PCT Filed: Aug. 21, 2006
(86) PCT No.: PCT/JP2006/316783

§ 371 Date: Feb. 21, 2008

(30) Foreign Application Priority Data
Aug. 22, 2005 (JP) 2005-239522

(51) Int. Cl. C23C 4/10; B32B 15/04; C23C 4/06; C23C 4/18; B05D 3/06; B05D 3/00

(52) U.S. Cl. 428/332; 428/469; 427/551; 427/554; 427/454

(57) ABSTRACT

For the purpose of solving problems inherent to a plasma spray coating of white base Al₂O₃—Y₂O₃ composite oxide, i.e. drawbacks that the corrosion resistance, heat resistance and abrasion resistance are poor and the light reflectance is high because the coating is porous and weak in the bonding force among particles, a spray coating member having an excellent heat emission property and the like is proposed wherein a surface of a substrate is covered with a spray coating of a colored composite oxide made of a low luminosity, achromatic or chromatic Al₂O₃—Y₂O₃.

### TECHNICAL FIELD

This invention relates to a spray coating member being excellent in various properties such as heat mission property, damage resistance, corrosion resistance, mechanical properties and the like as well as a method of producing the same, and more particularly to a technique for forming a spray coating of a composite oxide with a color such as dark gray or the like on a surface of a substrate.

### RELATED ART

The spraying method is a surface treating technique wherein a spraying powdery material of a metal, ceramic, cermet or the like is fused by a plasma flame or a combustion flame of a combustible gas and the fused particles are accelerated and blown onto a surface of an objective substrate to be sprayed, whereby the fused particles are gradually deposited to form a coating having a certain thickness. In the spray coating formed by such a process, a great difference is caused in the mechanical properties and chemical properties of the coating depending on the strong or weak bonding force among the mutually deposited particles constituting the coating or the presence or absence of non-bonded particles. Therefore, the conventional spraying technique aims at the development that the bonding force among the mutually fused particles through the complete fusion of the spraying powder material is strengthened to diminish the non-fused particles and a large acceleration force is applied to the flying fused particles to generate strong impact energy on the surface of the objective to be sprayed to thereby increase the bonding force between the particles, whereby the porosity is decreased or the adhesion force to the objective to be treated (substrate) is strengthened.

For example, JP-A-H01-139749 proposes a method wherein the bonding force among mutually metal particles is improved or oxide film produced on the surface of the particle, which is a cause of generating pores, is reduced by a plasma spraying process under a reduced pressure of plasma-spraying the metal particles in an argon atmosphere of 50-200 hPa.

According to this technical development could be recently improved the characteristics of the spray coating such as mechanical strength and the like, but there is no technique of improving the heat emission property. Particularly, there is no thinking of improving the characteristics such as heat emission property and the like by adjusting the surface color of the spray coating. In this connection, a typical color of the ceramic spray coating is deep green near to black in, for example, chromium oxide (Cr₂O₃) powder as a spraying powdery material, but when it is subjected to a plasma spraying, a black coating is formed. On the other hand, aluminum oxide (Al₂O₃) powder is pure white, and also a coating obtained by plasma spraying is pure white. Therefore, the color inherent to the respective spraying powdery material renders into a front color as it is.

Thus, it is typically common that the color of the ceramic spray coating is reproduced as a color of a spray coating formed at a state of the color inherent to the spraying powder material. Particularly, it is known that aluminum oxide (Al₂O₃) is strong in the chemical bonding force between Al and O₂ as a main component as compared with the other oxide ceramics and indicates a white color even if the coating is formed by a plasma spraying process using a gas plasma flame composed mainly of Ar gas as a heat source (a great amount of electrons are included in the plasma).

In order to improve the bonding force of the porous metallic spray coating or among the mutual spraying particles, there is a method defined according to JIS H8303 (self-fluxing alloy spraying). This method is a method wherein a spray coating is formed and then a surface of the spray coating is heated above a melting point thereof by oxygen-acetylene flame, a high frequency induction heating process, an electric furnace or the like. Besides, there is a method of melting the surface of the spray coating by irradiation of electron beams or laser beams. Moreover, these methods are known as a means for densifying the spray coating.

As a method of increasing the bonding force among mutual spraying particles, there is a technique of irradiating electron beams or the like. For example, there are disclosed a method of irradiating electron beams or laser beams onto a metal coating to re-melt the coating for sealing in JP-A-S61-104062, a method of irradiating electron beams onto a carbide cermet coating or a metal coating to improve the performances of the coating in JP-A-H09-316624, and a method of irradiating short-wavelength light beams onto a ceramic to render into a metallic state through detachment of oxygen atom to thereby develop the electric conductivity in JP-H09-048684.

However, these conventional techniques target at the metal coating or carbide cermet coating and are to diminish pores in the coating or improve the adhesiveness, and the method of irradiating the short wavelength light beams onto the ceramic coating is also disclosed for giving the electric conductivity to the coating, but they are not intended to intentionally change the color of the coating.

### DISCLOSURE OF THE INVENTION

The conventional spray coating, for example, the composite oxide spray coating of Al₂O₃ and Y₂O₃ is typically a white color of about (1-10)(Y, YR) (7-9)/(1-2) as a Munsell system, which is inherent to the color of the spraying power material. As the inventors' experience, this spray coating does not actually sufficiently correspond to the demand required in the field of recent sophisticated industry. That is,

(1) The spray coating of the white Al₂O₃ composite oxide is high in the light reflection ratio and could be said to be suitable as a coating member in the field requiring the good heat emission ratio.
(2) Since colored particles are adhered to the white spray coating under environments of the members used requiring a high cleanness as in an interior of the semiconductor processing apparatus, it is required to repeat the cleaning at a frequency exceeding the given times, which brings about the decrease of operation efficiency and the rise of product cost.
(3) The spray coating of the white Al₂O₃—Y₂O₃ composite oxide is a porous coating having a weak bonding force among the mutual particles and many voids (pores) because the contact areas among the spraying particles constituting the coating are small. Therefore, although the Al₂O₃—Y₂O₃ composite oxide itself has an excellent corrosion resistance, environmental corrosive components (for example, water, acid, salts, halogen gas and so on) are easily penetrated into the pores and hence the corrosion of the substrate or the peeling of the coating are easily caused.
(4) In the spray coating of the white Al₂O₃—Y₂O₃ composite oxide, the bonding force among mutual spray particles is weak, and hence if the coating is subjected to shock from exterior such as blast erosion or the like, the particles are apt to be locally fallen down and hence the durability of the coating is damaged from the fall-down portion as a starting of the breakage of the whole coating.
(5) The spray coating of white Al₂O₃—Y₂O₃ composite oxide is porous and has a weak bonding force among the particles and does not frequently pass through sufficient melting phenomenon in a hot spraying source. Therefore, it is easily etched during plasma etching or plasma cleaning treatment under an environment including fluorine gas, O₂ gas, fluoride gas or the like, and the durable life become short. Further, the coating particles after the plasma etching render into fine particles, which contaminate the environment and bring about the deterioration of the quality in the semiconductor product.
(6) Furthermore, the spray coating of the white Al₂O₃—Y₂O₃ composite oxide could not be subjected to precision work because the bonding force among the mutual particles constituting the coating is weak and the particles are frequently fallen down in the mechanical work of the coating.

The invention is developed in view of the above-mentioned problems of the conventional techniques and is to provide a spray coating member of a composite oxide having an excellent heat emission property, mechanical properties such as injury resistance, wear resistance and the like, chemical properties such as corrosion resistance and the like, resistance to plasma etching and so on.

The invention propose a spray coating member and a method of producing the same, which have the following summary and construction by further improving the conventional spray coating of Al₂O₃—Y₂O₃ composite oxide.

(1) A spray coating member having an excellent heat emission property and the like, which comprises a substrate and a spray coating of a colored composite oxide made of a low luminosity, achromatic or chromatic Al₂O₃—Y₂O₃ covering the surface of the substrate.

(2) A spray coating member having an excellent heat emission property and the like, wherein an undercoat made of a metal/alloy or cermet spray coating is disposed between the surface of the substrate and the spray coating of the colored composite oxide.

(3) A spray coating member having an excellent heat emission property and the like, wherein the spray coating of the colored composite oxide has a color formed by decreasing a luminosity inherent to spraying powder material or further decreasing a chromaticity thereof through electron beam irradiating treatment or laser beam irradiating treatment.

(4) A spray coating member having an excellent heat emission property and the like, wherein the spray coating of the colored composite oxide has a thickness of 50-2000 μm.

(5) A spray coating member having an excellent heat emission property and the like, wherein the undercoat is a metal sprayed coating of 50-500 μm in thickness made from at least one metal or an alloy selected from Ni and an alloy thereof, Mo and an alloy thereof, Ti and an alloy thereof, Al and an alloy thereof and Mg alloy, or a cermet.

(6) A method of producing a spray coating member having an excellent heat emission property and the like, which comprises spraying a spraying powder material of Al₂O₃—Y₂O₃ composite oxide having a high luminosity and a white color directly onto a surface of a substrate or onto a surface of an undercoat formed on the surface of the substrate, and then subjecting a surface of the thus sprayed coating of the white-color Al₂O₃—Y₂O₃ composite oxide to electron beam irradiation or laser beam irradiation to change the surface of the spray coating into a low luminosity achromatic or chromatic color.

(7) A method of producing a spray coating member having an excellent heat emission property and the like, wherein a layer of less than 50 μm located inward from the surface of the spray coating of the white-color Al₂O₃—Y₂O₃ composite oxide is changed into a low luminosity, achromatic or chromatic color through the electron beam irradiation or the laser beam irradiation.

(8) A method of producing a spray coating member having an excellent heat emission property and the like, wherein the spraying powder material of Al₂O₃—Y₂O₃ composite oxide having a high luminosity and a white color is plasma-sprayed directly onto the surface of the substrate or onto the surface of the undercoat of the metal spray coating formed on the surface of the substrate to form the colored composite oxide spray coating made of low luminosity, achromatic or chromatic Al₂O₃—Y₂O₃.

(9) A method of producing a spray coating member having an excellent heat emission property and the like, wherein the plasma-spraying is carried out in an atmosphere having a partial oxygen pressure lower than air.

In the invention, the white-based Al₂O₃—Y₂O₃ composite oxide spray coating is basically excellent in various properties, for example, resistance to plasma erosion in an atmosphere of a halogen or halogen compound gas, so that it is suitable as a member for recent semiconductor processing apparatus requiring a precise working accuracy and a clean environment, and hence it can largely contribute to improve the quality and productivity of semiconductor processed products. In addition, according to the invention, the surface color of the spray coating is rendered into a deep gray color such as ash gray and hence the heat emission property and the damage resistance are excellent, while when it is particularly subjected to the electron beam irradiation or laser beam irradiation, the surface of the coating becomes smooth and the Al₂O₃—Y₂O₃ composite oxide particles constituting the coating are fused together to form a dense coating, and hence the sliding property, corrosion resistance, abrasion resistance and the like are considerably improved, and it is possible to use the coating as a product in industrial fields over a long time.

Further, the colored Al₂O₃—Y₂O₃ composite oxide spray coating according to the invention is desirable as a protection coating for a heating heater and the like requiring high heat emission property and heat receiving efficiency.

Moreover, according to the invention, the spray coating members having the above-mentioned properties can be advantageously produced by adopting the electron beam irradiation or laser beam irradiation.

### BRIEF DESCRIPTION OF THE DRAWINGS

FIG. 1(a) is a photograph of a spray coating of Al₂O₃—Y₂O₃ composite formed by an atmospheric plasma spraying process of the conventional technique using a powder material of white Al₂O₃—Y₂O₃ composite oxide, and FIG. 1(b) is a photograph of Al₂O₃—Y₂O₃ composite oxide spray coating according to the invention formed by irradiating electron beams to the surface of the white Al₂O₃—Y₂O₃ composite oxide to change into a deep gray color.

FIG. 2 is an optical microphotograph (SEM-BEI image) showing a surface and a section of a spray coating of Al₂O₃—Y₂O₃ composite oxide after the electron beam irradiation.

FIG. 3 schematically shows a section of Al₂O₃—Y₂O₃ composite oxide spray coating, wherein FIG. 3(a) is before electron beam irradiation and FIG. 3(b) is after electron beam irradiation.

### BEST MODE FOR CARRYING OUT THE INVENTION

In the invention, it is one of features that white base coating inherent to a spraying powder material and a spray coating thereof is rendered into a highly-colored spray coating, i.e. achromatic or chromatic spray coating having a low V-value (luminosity) as Munsell system. That is, according to the invention, the color of the spraying powder material of about (1-10)(Y, YR)(7-9)/(1-2) as Munsell system is made to an achromatic color of N-7.0 (pearl gray) or N-6.1 (tinted black), preferably N-5.0 (gray) or N-4.0 (dull color), or a color that a luminosity (V) of three-attribute scale (Munsell system) is represented by not more than V-7.5 (corresponding to N-7.5), preferably not more than V-6.5, for example, ash color (2.5Y 6/1), sepia color (10YR 2.5/2) or the like.

These colors can be realized by controlling the irradiating conditions of electron beams or laser beams to a spray coating as mentioned later. Hereinafter, the spray coating added with the above color in the invention is called as a colored spray coating as compared with the white base spray coating.

Next, the production method of the colored Al₂O₃—Y₂O₃ composite oxide spray coating of gray (N-5.0) or the like suitable for the invention will be described and also the features of the colored composite oxide spray coating will be explained.

(1) Method of producing members by formation of Al₂O₃—Y₂O₃ composite oxide spray coating

The Al₂O₃—Y₂O₃ composite oxide spray coating is formed by roughening a surface of a body to be sprayed (substrate) through a blast treatment and applying a commercially available spraying powder material of white Al₂O₃—Y₂O₃ composite oxide directly onto the surface thereof or onto a surface of an undercoat made of a metallic undercoat firstly formed on the surface of the substrate through a plasma spraying method or the like. The appearance of the spray coating is initially a white base coating likewise the spraying powder material.

In the invention, a spraying method such as an atmospheric plasma spraying method, a plasma spraying method under a reduced pressure, a high-speed flame spraying method, an explosion spraying method, a water plasma spraying method using water as a plasma source or the like can be applied to the formation of Al₂O₃—Y₂O₃ composite oxide spray coating sprayed on the surface of the substrate. All of the appearances of Al₂O₃—Y₂O₃ composite oxide coatings formed by these spraying methods are a white color system.

Moreover, the spray coating of Al₂O₃—Y₂O₃ composite oxide, which is obtained by the plasma spraying method in an inert gas atmosphere containing substantially no oxygen under a reduced pressure or the atmospheric plasma spraying method flowing an inert gas or N₂ gas around a plasma heat source so as not to incorporate air thereinto, shows substantially sky gray (luminosity (V): 7.5) as a color tone irrespectively of somewhat shading, so that this spray coating is effective for improving the heat emission property without irradiating electron beams or laser beams as mentioned later, and is at least effective as a colored spray coating suitable for the invention.

In the formation of the Al₂O₃—Y₂O₃ composite oxide spray coating according to the invention, the undercoat is first formed on the surface of the substrate and then the coating may be formed thereon. In this case, it is preferable that at least one metal/alloy selected from Ni and an alloy thereof, Mo and an alloy thereof, Ti and an alloy thereof, Al and an alloy thereof and Mg alloy or a cermet of such an alloy with various ceramics is used as a material for the undercoat and is applied at a thickness of about 50-500 μm.

The undercoat plays a role for blocking the surface of the substrate from corrosive environment to improve the corrosion resistance but also improve the adhesion property between the substrate and Al₂O₃—Y₂O₃ composite oxide. Therefore, when the thickness of the undercoat is less than 50 μm, the action mechanism as the undercoat (chemical protection action for the substrate) is weak but also the uniform formation of the coating is difficult, while when the thickness of the undercoat exceeds 500 μm, the coating effect is saturated and the lamination working time is increased to bring about the rise of the production cost.

Also, the thickness of the Al₂O₃—Y₂O₃ composite oxide spray coating always being a top coat is preferably within a range of about 50-2000 μm. When the thickness is less than 50 μm, the equality of the coating thickness is lacking and also the functions as the oxide ceramic coating, for example, heat resistance, heat insulating property, corrosion resistance, abrasion resistance and the like could not be developed sufficiently. While, when the thickness exceeds 2000 μm, the bonding force among mutual particles constituting the coating becomes further weak and also the residual stress of the coating (stress generated associated with the shrinkage of the volume on the way of cooling the fused and deposited spraying particles) becomes large, and hence the strength of the coating itself lowers and the coating is easily broken even though the action of slight external force.

Further, the Al₂O₃—Y₂O₃ composite oxide used as spraying powder material in the invention is represented by 3Y₂O₃·5Al₂O₃ (═Y₃Al₅O₁₂) as an accurate molecule formula, which is a composite oxide of yttrium oxide (Y₂O₃) and aluminum oxide (Al₂O₃) and has a melting point of about 1900° C. and a colorless, transparent cubic crystal and a garnet structure.

As the spraying powder material in the invention, powder having a particle size range of 5-80 μm formed by pulverizing the above composite oxide is used. When the particle size of the powder material is less than 5 μm, since the powder has no fluidity, it could not be evenly supplied to a spraying gun and the thickness of the spray coating becomes unequal. While, when the particle size exceeds 80 μm, the material is not completely fused in a spraying hot source, and hence the coating becomes rough and the bonding force to the substrate and the undercoat is undesirably deteriorated.

The substrate for the formation of the spray coating could be Al and Al alloy, corrosion-resistant steel such as stainless steel, Ti and an alloy thereof, ceramic sintered bodies (for example, oxide, nitride, boride, silicide, carbide and a mixture thereof), and raw materials such as quartz, glass, plastics and the like. As the substrate in the invention, various plated layers or vapor deposit layer formed on these raw materials could also be used.

(2) Electron Beam or Laser Beam Irradiation Treatment to Al₂O₃—Y₂O₃ Composite Oxide Spray Coating

According to the invention, electron beams or laser beams (hereinafter referred to as “electron beam or the like) are irradiated to the aforementioned white base Al₂O₃—Y₂O₃ composite oxide spray coating having a white color inherent to the spraying powder material. For example, the electron beam irradiation treatment is applied to the white, achromatic Al₂O₃—Y₂O₃ composite oxide coating formed by the atmospheric plasma spraying method or the achromatic (N-7.5) or chromatic Al₂O₃—Y₂O₃ composite oxide coating having a somewhat small N-value obtained through plasma spraying with an atmospheric plasma hot source shielded by Ar or N₂ gas or in an Ar gas atmosphere under a reduced pressure for further decreasing the luminosity to make the color deeper. By such an electron beam irradiation treatment the white base achromatic spray coating is changed into a small N-value such as gray, while the spray coating having a relatively small N-value (about N-7.5) previously and slightly grayed at the sprayed state is maintained with the color as it is or changed into a deeper achromatic color (N≦7.0) depending on the irradiation conditions.

As the condition for electron beam irradiation, the following conditions after an inert gas (Ar gas or the like) is introduced into an irradiation chamber discharging air are recommended.

Irradiating atmosphere: 0.0005 Pa
Irradiating power output: 0.1-8 kW
Irradiating speed: 1-30 m/s

However, the irradiation effect was recognized even when using an electron gun having a large power output as mentioned in the following examples, and therefore the conditions are not limited to only the aforementioned conditions.

As the irradiation of the laser beams, it is possible to use YAG laser utilizing YAG crystal, or CO₂ gas laser or the like. As the laser beam irradiation treatment, the following conditions are recommended, but not necessarily fulfilled if the irradiation effect can be obtained up to a depth of 50 μm from the surface of the spray coating likewise the above-mentioned case.

Laser power output: 0.1-10 kW
Laser beam area: 0.01-2500 mm²
Irradiating speed: 5-1000 mm/s

In the spray coating of Al₂O₃—Y₂O₃ composite oxide irradiated with such electron beams or the like, the temperature of the composite oxide particles rises from the surface and finally becomes a molten state over the melting point, and at this stage the white Al₂O₃—Y₂O₃ composite oxide spraying particles change into deeper gray (about N-5). The melting phenomenon of these particles is gradually extended to the interior of the coating by increasing the irradiating power output of the electron beams or increasing the irradiation number or prolonging the irradiating time, so that the depth of the irradiating molten layer can be controlled by changing such irradiating conditions. In practice, as long as the melting depth is 1-50 μm, the coating suitable for the invention is obtained. Moreover, when the melting depth is less than 1 μm, the effect of forming the coating is not obtained, while when it exceeds 50 μm, the burden of high energy irradiation treatment becomes large and the effect of forming the coating is saturated.

As the inventors' knowledge, it is considered that the phenomenon of changing the white Al₂O₃—Y₂O₃ composite oxide spray coating into a deeper gray (about N-5) or the like by the irradiation of electron beam or the like is based on the intervention of the following reaction. It is thought due to the fact that the spray coating according to the invention results from the composite oxide of Al₂O₃ and Y₂O₃. According to the inventors' studies, the color in the spray coating of Al₂O₃ alone is not frequently changed even by the irradiation of electron beam or the like. On the contrary, the coating of Y₂O₃ alone is easily changed into black color by the irradiation of electron beam or the like and subsequently maintained at a stable color tone. From such experiences, the inventors have thought that the color change of Al₂O₃—Y₂O₃ composite oxide through the irradiation of electron beam or the like is largely depended on the action of Y₂O₃ in the composite oxide.

On the other hand, presuming the chemical bonding force between metallic element and oxygen in each of Al₂O₃ and Y₂O₃, the bonding force between Al and O is very strong, and once the oxide is formed, it is unchangeable even if it is subsequently placed under an environment having a very small oxygen partial pressure. While, the oxide Y₂O₃ easily changes into a black color even in an atmosphere such as plasma spraying under a reduced pressure, which leads to the assumption that Y₂O₃ could be rendered into Y₂O₃₋ₓ compound by releasing a part of oxygen in its molecular formula.

The aforementioned phenomena are mainly considered to result in the change of the white Al₂O₃—Y₂O₃ composite oxide into the deeper gray (about N-5) or the like through the irradiation of electron beam or the like.

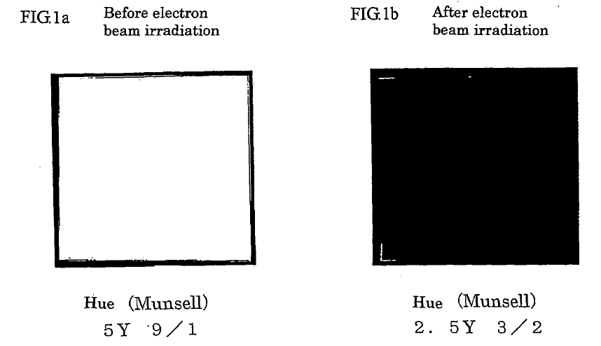

FIG. 1 shows appearance states of (a) a spray coating of white Al₂O₃—Y₂O₃ composite oxide just after the spraying and (b) a coating after electron beams are irradiated to the surface of the white spray coating, respectively. Moreover, FIG. 1(a) shows that an atmosphere plasma is directly sprayed onto a one-side surface of an aluminum test piece (A5052) having a width×length×thickness of 50×50×10 mm to form a spray coating of Al₂O₃—Y₂O₃ composite oxide having a thickness of 250 μm, which is then subjected to a plane polishing work, and FIG. 1(b) shows that electron beams are irradiated onto the surface of the spray coating of FIG. 1(a) under condition that an acceleration voltage is 28 kV and that an irradiating atmosphere is <0.1 Pa.

As a result, the color of the spray coating before the electron beam irradiation in FIG. 1(a) is 5Y 9/1, while the color of the spray coating after the electron beam irradiation in FIG. 1(b) is 2.5Y 3/2 due to the lowering of the luminosity and shows approximately a dark gray (seaweed color) (2.5Y 4.5/2.4) or ash color (2.5Y 6/1).

(3) Outline of Appearance and Section of Spray Coating of Al₂O₃—Y₂O₃ Composite Oxide Subjected to Irradiation of Electron Beam or the Like

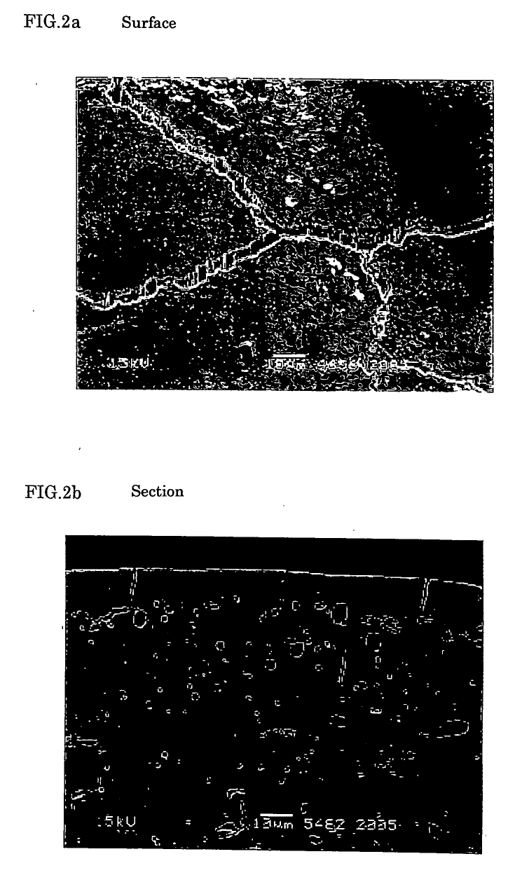

As the inventors' studies, the appearance of Al₂O₃—Y₂O₃ composite oxide spray coating subjected to the irradiation treatment of electron beam or the like changed into a deeper gray (about N-5), while as the surface was observed through an enlarged view, small cracks were found in a network form. The surface and section of the coating are shown in FIGS. 2(a) and (b) as observed by an optical microscope (SEM-BEI image). It is considered that the network-shaped cracks are generated when Al₂O₃—Y₂O₃ composite oxide particles melted by electron beam or the like are fused with each other to form a large smooth face and thereafter the volume is shrunk at the cooling stage. As seen from FIG. 2(b), the network-shaped cracks are limited to the surface of the irradiated portion and do not penetrate into the interior of the coating, so that they do not exert on the corrosion resistance of the coating. Moreover, crack-free irradiated face may be formed by pre-heating the irradiated portion or by slowly cooling after the irradiation.

On the other hand, a coating structure having many pores, which is inherent to the ceramic spray coating of Al₂O₃—Y₂O₃ composite oxide, remains in the underlayer portion below the electron beam irradiating influenced portion (portion of the coating changed by irradiation), so that such a coating structure is considered to advantageously act to thermal shock.

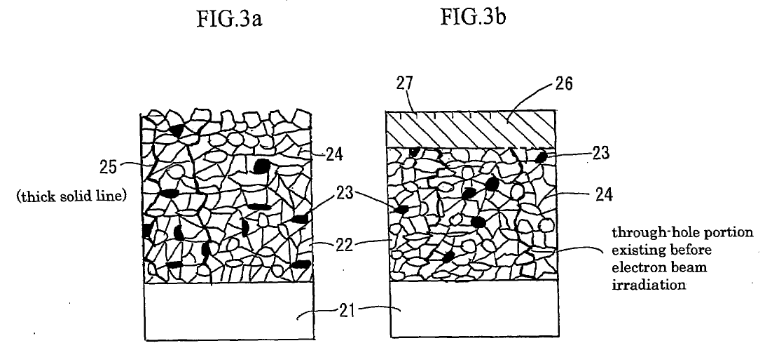

FIG. 3 schematically shows section state of a spray coating before or after electron beam irradiation. In the non-irradiated portion shown in FIG. 3(a), the spraying particles constituting the coating are independently deposited in the form of stone wall, and the surface roughness becomes large and the presence of various big and small gaps (pores) is observed. On the other hand, in the irradiated portion shown in FIG. 3(b), a new layer having different microstructure is formed on the spray coating of the Al₂O₃—Y₂O₃ composite oxide particles. This new layer is a dense layer having less gaps by fusing the spraying particles with each other.

Moreover, numeral 21 in FIG. 3 is a substrate, numerals 22 are Al₂O₃—Y₂O₃ composite oxide particles constituting the coating, numerals 23 are gap portions of the coating, numerals 24 are grain boundary portions of Al₂O₃—Y₂O₃ composite oxide particles, numeral 25 is a through-pore portion along the grain boundary, numeral 26 is a fused portion of Al₂O₃—Y₂O₃ composite oxide through electron beam irradiation, and numerals 27 are fine heat-shrinkage cracks generated in an electron beam irradiated layer produced in the vicinity of the surface of the Al₂O₃—Y₂O₃ composite oxide spray coating.

(4) Features of Al₂O₃—Y₂O₃ Composite Oxide Spray Coating Irradiated by Electron Beam or the Like

The colored Al₂O₃—Y₂O₃ composite oxide spray coating according to the invention possesses the following functions without damaging physical and chemical properties of the conventional typical white Al₂O₃—Y₂O₃ composite oxide coating formed by plasma spraying or the like (for example, it is hard and excellent in the abrasion resistance and has corrosion resistance and electric insulating property).

(a) As previously mentioned, the spray coating of Al₂O₃—Y₂O₃ composite oxide irradiated by electron beam or the like changes from white color just after the spraying into a deep gray (about N-5) color, and hence light reflectance lowers and absorption efficiency of radiant heat is improved, so that a new evolution to members utilizing the change of color tone could be expected.
(b) The surface of Al₂O₃—Y₂O₃ composite oxide spray coating irradiated by electron beam or the like is completely melted once and integrally united by fusing Al₂O₃—Y₂O₃ composite oxide particles of about 5-80 μm constituting the coating with each other, so that the mechanical strength in the vicinity of the surface of the spray coating (from the surface up to a depth of 50 μm) is improved and hence the coating is hardly broken.
(c) The surface of the Al₂O₃—Y₂O₃ composite oxide spray coating is considerably smoothened by the irradiation of electron beam or the like because the maximum roughness (Ry) of the surface before the irradiation treatment is 16-32 μm but the maximum roughness (Ry) after the irradiation treatment becomes about 6-18 μm owing to the melting phenomenon, and hence unmelted particles inherent to the spray coating or composite oxide particles convexly adhered thereto become extinct to improve the sliding property. The mechanical working precision of the spray coating surface is also improved, whereby spray coating members having a high precision could be produced.
(d) In the surface of Al₂O₃—Y₂O₃ composite oxide spray coating irradiated by electron beam or the like, pores existing in the spray coating, particularly through-holes passing from the surface of the coating to the substrate come off by the melting phenomenon, so that the corrosion resistance of not only the coating but also the substrate are improved dramatically.
(e) In the surface of Al₂O₃—Y₂O₃ composite oxide spray coating irradiated by electron beam or the like, the resistance to plasma erosion is considerably improved by the actions and effects of the above items (a)-(d). Therefore, when the colored Al₂O₃—Y₂O₃ composite oxide spray coating irradiated by electron beam or the like according to the invention is applied to a surface of a member for semiconductor production-inspection-working apparatus requiring the clean environment, the resistance to plasma erosion is improved and the phenomenon of generating particles as an environmental contamination source lowers. As a result, the invention develops the remarkable effect in the maintenance of environment cleanness and largely contributes to the improvement of the productivity accompanied with the decrease of cleaning number of the apparatus.

### EXAMPLES

### Example 1

In this example, a spray coating of Al₂O₃—Y₂O₃ composite oxide having a thickness of 50 μm was formed on a surface of a protection tube made of quartz glass and having a built-in heating wire by atmospheric plasma spraying method, and the surface of the spray coating was further subjected to an electron beam irradiation to change the color of the surface from white color to a light gray (about N-6.5) or deep gray (about N-5) color. Then, wavelength emitted from the surface of the spray coating by flowing current to the heating wire in the protection tube was measured by utilizing a method of measuring a spectral reflectance defined according to JIS R1801. As a result, the wavelength of about 0.2-0.9 μm was detected on the surface of the white Al₂O₃—Y₂O₃ composite oxide spray coating, while the wavelength of 0.3-4.2 μm was detected on the surface of the colored spray coating changed into gray color by the electron beam irradiation, from which the emission of the wavelength in infrared ray zone was recognized so that the effectiveness had been confirmed when applied to a heater.

Also, the heat emission property was examined when the composite oxide spray coating having the deep gray color (about N-5) suitable for the invention was applied to a surface of a high brightness halogen lamp instead of the electric wire (heater) of the protection tube made of quartz glass. The wavelength of the lamp having no spray coating was 0.2-3 μm, while the wavelength usable in a far-infrared ray zone of 0.3-8 μm was detected in the lamp covered with the spray coating irradiated by electron beams, from which it is clear that the efficiency had been improved as the heater.

### Example 2

An atmospheric plasma spray coating of 80 mass % Ni-20 mass % Cr alloy (thickness: 100 μm) was formed on a one-side surface of SUS 304 steel substrate (dimension: 50 mm in width×50 mm in length×3.5 mm in thickness) as an undercoat, and thereafter a topcoat of 250 μm in thickness was laminated thereon by using commercially available white base Al₂O₃—Y₂O₃ composite oxide spraying powder material through an atmospheric plasma spraying method or a plasma spraying method under a reduced pressure in Ar atmosphere substantially having no oxygen. The appearance color of the topcoat was white in the atmospheric plasma spraying, and light gray (about N-7.5) in the plasma spraying under the reduced pressure. Thereafter, the surface of each of these topcoats was subjected to an electron beam irradiation, and then the appearance observation, microstructure of coating section, porosity and the like were examined on the resulting spray coating test pieces, while the thermal shock test was carried out to examine the change of general property of the spray coating due to the presence or absence of electron beam irradiation treatment.

Table 1 summarizes the above results. Moreover, the production conditions of the coating and the test method and conditions thereof are also shown below the table.

TABLE 1

| | | | | Presence or absence of electron | | | | | |
|---|---|---|---|---|---|---|---|---|---|
| | | | Presence | beam irradiation and color of | | | Result | Adhesion | |
| | | | or | coating | | Porosity | of | strength | |
| | | Appearance | absence | Presence or | | of | thermal | of | |
| | Spraying | color of | of | absence of | Appearance | coating | shock | coating | |
| No. | method | coating | undercoat | irradiation | color | (%) | test | (Mpa) | Remarks |
| 1 | Atmospheric | White | presence | absence | White | 3-8 | no | 33-35 | Comparative |
| | plasma | | | | | | peeling | | Example |
| 2 | spraying | White | presence | presence (3 μm) | deep gray | 0.1-0.3 | no | 34-37 | Invention |
| | | | | | | | peeling | | Example |
| 3 | | White | presence | presence (5 μm) | deep gray | 0.1-0.2 | no | 37-40 | Invention |
| | | | | | | | peeling | | Example |
| 4 | Plasma | light gray | presence | absence | Somewhat | 0.4-0.7 | no | 35-39 | Invention |
| | spraying | | | | deep gray | | peeling | | Example |
| 5 | under | light gray | presence | presence (3 μm) | deep gray | 0.1-0.2 | no | 36-41 | Invention |
| | reduced | | | | | | peeling | | Example |
| | pressure | | | | | | | | |

(Note)
(1) Three test pieces were used every one condition, and numerical values in the column “presence or absence of electron beam irradiation” are thickness of a melted layer in the coating through irradiation.
(2) Ar pressure in the plasma spraying under a reduced pressure is 50-150 hPa.
(3) The thickness of the undercoat (80Ni—20Cr) in the coating is 100 μm, and the thickness of Al₂O₃—Y₂O₃ composite oxide as a topcoat is 180 μm.
(4) The porosity of the coating was measured by an image analyzing apparatus for the section of the coating.
(5) The adhesion property of the coating was measured by the adhesion strength test method defined according to ceramic spraying test method of JIS H8666.
(6) The thermal shock test by heating of 350° C. × 15 min [symbol] air cooling (25° C.) was repeated 10 times.
(7) The deep gray is about N-5.5 in Munsell system (gray), and somewhat deep gray is about N-6 in Munsell system (light black), and light gray is about N-7.5 in Munsell system (sky gray).

As seen from the above results, the spray coatings suitable for the invention irradiated by electron beams (No. 2, 3 and 5) showed the deep gray color after the electron beam irradiation, the resistance to thermal shock of the coating and the adhesion strength to the undercoat were equal to those of the white composite oxide coating in the comparative example.

As to the porosity of the spray coating, spray coating irradiated by electron beam and suitable for the invention had clearly more density. This is considered due to the fact that the Al₂O₃—Y₂O₃ composite oxide particles existing on the surface of the coating were melted and fused to each other by the irradiation of electron beams. Particularly, it is considered be the result of the fusion including even particles not heated sufficiently in the spraying heat source, and incorporated into the plasma spray coating at a non-molten state to raise the porosity of the coating. However, the spraying particles smoothed by melting and the presence of micro-cracks had been confirmed at the surface of the coating when observed by means of a magnifying glass, and it had been confirmed that the surface was not a complete non-pore state. This is considered due to the fact that the spray coating melted by the electron beam irradiation had been shrunk at the cooling stage to generate new micro-cracks. However, it is considered that such micro-cracks will not grow in the interior of the spray coating as a through-hole, so that they will not exert on the performances of the coating as a whole such as corrosion resistance, resistance to plasma erosion and the like.

Moreover, the electron beam irradiation apparatus used in this example had the following specifications.

Rated output of electron gun: 6 kW
Acceleration voltage: 30-60 kV
Beam current: 5-100 mA
Beam diameter: 400-1000 μm
Irradiation atmosphere pressure: 6.7-0.27 Pa
Irradiation distance: 300-400 mm.

### Example 3

After a one-side surface of SS400 steel test piece (dimension: width 50 mm×length 100 mm×thickness 3.2 mm) was subjected to a blast treatment, a spraying powder material of Al₂O₃—Y₂O₃ composite oxide was directly sprayed on the treated surface by an atmospheric plasma spraying method to form a coating of 150 μm in thickness. Thereafter, the surface of Al₂O₃—Y₂O₃ composite oxide spray coating was subjected to an electron beam irradiation treatment. In this case, spray coatings had been provided wherein the influence of electron beam irradiation was located at a distance from the surface of 3 μm, 5 μm, 10 μm, 20 μm, 30 μm or 50 μm by changing electric output of the electron beam irradiation, irradiation number and the like to control the molten state (melting depth) of Al₂O₃—Y₂O₃ composite oxide particles on the surface of the spray coating.

Onto the exposed part of the substrate such as side face and rear face of the test piece after the electron beam irradiation, a paint having a corrosion resistance was applied, which was subjected to a slat spray test defined according to JIS Z2371 to examine the corrosion resistance of the spray coating.

Moreover, as Al₂O₃—Y₂O₃ composite oxide spray coating of Comparative Example, an atmospheric plasma spray coating not irradiated by electron beams was subjected to the slat spray test.

Table 2 summarizes the results of the salt spray test. As seen from these results, many pores inherent to the ceramic spraying were existent in the Al₂O₃—Y₂O₃ composite oxide spray coating of the comparative example (No. 1), so that red rust was generated over the full surface of the test piece after 24 hours, and the subsequent test had been stopped.

On the contrary, the occurrence of red rust had not been observed in the test pieces irradiated by electron beams (No. 2-7) after 48 hours. Only in the test pieces (No. 2 and 3) having a thin thickness of molten layer on the surface of the coating through the electron beam irradiation, the occurrence of small red rust had been first observed in 2-3 places after the 96 hours, while the other test pieces did not show the occurrence of red rust at all.

As seen from the above results, it had been found that the Al₂O₃—Y₂O₃ composite oxide spray coating irradiated by electron beams was melted and fused together at its surface by electron beams to completely eliminate pores existing in the coating, particularly a part of through-holes extending to the substrate, which prevented salt water from arriving at the surface of the substrate through the interior of the coating.

Moreover, micro-cracks were existent even at the electron beam irradiated faces, but these cracks were found to be generated only on the surface portion when the molten Al₂O₃—Y₂O₃ composite oxide particles became shrunk by cooling and not a large crack like extending to the substrate, therefore not affecting the corrosion resistance of the coating.

TABLE 2

| | | | Presence or absence of | | | | | |
|---|---|---|---|---|---|---|---|---|
| | | | electron beam | | | | | |
| | | | irradiation and | | | | | |
| | | Spray | influence depth thereof | | Results of salt spray test | | | |
| | | coating | presence or | Influence | after | | | |
| No. | Substrate | material | absence | depth μm | 24 h | after 48 h | after 96 h | Remarks |
| 1 | SS400 | Al₂O₃—Y₂O₃ | absence | — | X | not carried | not carried | Comparative |
| | | composite | | | | out | out | Example |
| 2 | | oxide | presence | 3 | ◯ | ◯ | Δ | Invention |
| | | | | | | | | Example |
| 3 | | | presence | 5 | ◯ | ◯ | Δ | Invention |
| | | | | | | | | Example |
| 4 | | | presence | 10 | ◯ | ◯ | ◯ | Invention |
| | | | | | | | | Example |
| 5 | | | presence | 20 | ◯ | ◯ | ◯ | Invention |
| | | | | | | | | Example |
| 6 | | | presence | 30 | ◯ | ◯ | ◯ | Invention |
| | | | | | | | | Example |
| 7 | | | presence | 50 | ◯ | ◯ | ◯ | Invention |
| | | | | | | | | Example |

(Note)
(1) The thickness of the spray coating is 150 μm.
(2) The slat spray test was carried out according to JIS Z2371.
(3) Symbols in the results of the salt spray test mean the following contents.
◯: no red rust,
Δ: occurrence of red rust at less than 3 places,
X: occurrence of red rust over full face

### Example 4

In this example, the abrasion resistance had been compared between electron beam irradiated spray coating of Al₂O₃—Y₂O₃ composite oxide as a top coat and the spray coating not irradiated by electron beam using the test piece of Example 2. The test apparatus and conditions thereof were as follows.

Test method: reciprocal moving abrasion test method defined according to a test method for abrasion resistance of a plating of JIS H8503
Test conditions: load of 3.5 N, 10 minutes (400 times) and 20 minutes (800 times) at a reciprocal speed of 40 times/min, abrasive area 30×12 mm, abrasion test paper CC320

The evaluation was conducted by measuring weights of the test piece before and after the test and quantifying an abrasion quantity from the difference thereof.

The test results are shown in Table 3. As seen from the results, the Al₂O₃—Y₂O₃ composite oxide spray coatings having a smooth coating surface (No. 2, 3 and 5), which are suitable for the invention, have been found less in the abrasion quantity as compared with the white spray coating of the comparative example and the coating having a gray color but not irradiated by electron beam (No. 4), and developing an excellent abrasion resistance.

TABLE 3

| | | | | Presence or absence of | | | Weight reduction | | |
|---|---|---|---|---|---|---|---|---|---|
| | | | | electron beam irradiation | | | quantity by | | |
| | | | | and color of coating | | | abrasion test | | |
| | | Appearance | Presence or | presence or | | | (mg) | | |
| | Spraying | color of | absence of | absence of | appearance | Porosity of | after 400 | after 800 | |
| No. | method | coating | undercoat | irradiation | color | coating (%) | times | times | Remarks |
| 1 | Atmospheric | white | presence | absence | white | 3-8 | 38-57 | 72-91 | Comparative |
| | plasma | | | | | | | | Example |
| 2 | spraying | white | presence | presence | deep gray | 0.1-0.3 | 18-30 | 30-38 | Invention |
| | | | | (3 μm) | | | | | Example |
| 3 | | white | presence | presence | deep gray | 0.1-0.2 | 18-28 | 28-39 | Invention |
| | | | | (5 μm) | | | | | Example |
| 4 | Plasma | light gray | presence | absence | somewhat | 0.4-0.7 | 35-55 | 68-88 | Comparative |
| | spraying | | | | deep gray | | | | Example |
| 5 | under | light gray | presence | presence | deep gray | 0.1-0.2 | 19-31 | 31-40 | Invention |
| | reduced | | | (3 μm) | | | | | Example |
| | pressure | | | | | | | | |

(Note)
(1) Three test pieces per one test, numeral in the column of “presence or absence of electron beam irradiation” shows a thickness of molten layer in the coating.
(2) Plasma spraying condition under reduced pressure is Ar atmospheric pressure of 50-150 hPa.
(3) In the coating, thickness of undercoat (80Ni—20Cr) is 100 μm and thickness of Al₂O₃—Y₂O₃ composite oxide as a top coat is 180 μm.
(4) The porosity of the coating was measured by an image analyzing apparatus for coating section.
(5) The abrasion-resistant test of the coating was carried out by a reciprocal moving abrasion test method defined according to a test method for abrasion resistance of a plating of JIS H8503.
(6) Deep gray is about N-5.5 (gray) as Munsell system, somewhat deep gray is about N-6 (light black) as Munsell system, light gray is about N-7.5 (sky gray) as Munsell system.

### Example 5

In this example a resistance to fluorine gas in the deep gray Al₂O₃—Y₂O₃ composite oxide spray coating irradiated by electron beam according to the invention was examined. On a one-side surface of a test piece of SUS 304 steel (size: width 30 mm×length 50 mm×thickness 3.2 mm) as a substrate was directly sprayed a spraying powder material of white base Al₂O₃—Y₂O₃ composite oxide in an atmospheric plasma to form a spray coating having a thickness of 150 μm. Thereafter, the spray coating was melted within a range of 5 μm from the surface and densified by an electron beam irradiation treatment.

The test piece having the thus treated spray coating was placed in an autoclave wherein air was removed and HF gas was introduced so as to have a partial pressure of 100 hPa, and then the autoclave was heated to 300° C. to conduct a continuous corrosion test of 100 hours. Moreover, the same test was made under the same conditions on the substrate (SUS 304) and the spray coating of Al₂O₃—Y₂O₃ composite oxide not irradiated by electron beam as a comparative example.

The results are shown in Table 4. In No. 1 spray coating (comparative example), the substrate of SUS 304 steel was violently corroded by HF gas to generate fine red rust over a full face of the test piece. Also, in the white Al₂O₃—Y₂O₃ composite oxide spray coating not irradiated by electron beam (No. 2), the coating itself was sound, but was completely peeled off from the substrate of SUS 304 steel, and hence the occurrence of red rust was observed on the surface of the substrate.

From this result, it is considered that the joint force between the substrate and the coating in the Al₂O₃—Y₂O₃ composite oxide spray coating not irradiated by electron beam had been lost due to the corrosion of the substrate with HF gas penetrated inward through pore portions of the coating.

On the contrary, in the Al₂O₃—Y₂O₃ composite oxide spray coatings irradiated by electron beam, it is considered that the higher HF resistance had been developed because the through-holes extending to the substrate were very less and the peeling of the coating was not caused though micro-cracks generated in the cooling solidification from the molten state were existent on the surface of the coating irradiated by electron beam.

TABLE 4

| | | | Presence or | | | Result of | |
|---|---|---|---|---|---|---|---|
| | | | absence of | Appearance of coating | | corrosion test | |
| | | Spray coating | electron beam | before | after | HF gas-300° C.- | |
| No. | Substrate | material | irradiation | irradiation | irradiation | 100 h | Remarks |
| 1 | SUS 304 | — | — | — | — | occurrence of | Comparative |
| | | | | | | red rust over | Example |
| | | | | | | full face | |
| 2 | | Al₂O₃—Y₂O₃ | absence | white | — | peeling of | Comparative |
| | | composite | | | | coating | Example |
| 3 | | oxide | presence | white | deep gray | occurrence of | Invention |
| | | | | | | red rust at two | Example |
| | | | | | | places. | |
| | | | | | | no peeling of | |
| | | | | | | coating | |
| 4 | | | presence | white | deep gray | no peeling of | Invention |
| | | | | | | coating | Example |

(Note)
(1) Thickness is 150 μm in atmospheric plasma spraying method.
(2) Thickness of molten layer in the coating through electron beam irradiation is 5 μm.
(3) Deep gray is about N-5.5 as Munsell system.

### Example 6

In this example a resistance to plasma erosion of Al₂O₃—Y₂O₃ composite oxide spray coating irradiated by electron beam according to the invention was examined. As an electron beam, the same irradiated test piece as in Example 5 was used and subjected to a continuous treatment at a plasma output of 80 W for an irradiating time of 500 minutes with a reactive plasma etching apparatus in an atmosphere consisting of 60 ml/min of CF₄ gas and 2 ml/min of O₂. Moreover, as a test piece of a comparative example, Al₂O₃—Y₂O₃ composite oxide spray coating formed by atmospheric plasma spraying and SiO₂ spray coating were tested under the same conditions.

The test results are shown in Table 5. The plasma erosion quantity of the Al₂O₃—Y₂O₃ composite oxide spray coating as the comparative example was 1.2-1.4 μm, while the erosion quantity of the Al₂O₃—Y₂O₃ composite oxide spray coating irradiated by electron beam was reduced to 25-40%, from which it is clear that the resistance to erosion had been improved by densification of the surface of the spray coating. Moreover, the SiO₂ coating as another comparative example was easily subjected to a chemical action of CF₄ gas, and showed its erosion quantity as 20-25 μm, which was maximum among those of the tested coatings, from which it is confirmed that the latter coating could not be used under this type of the environment.

TABLE 5

| | | | Presence or absence | | | |
|---|---|---|---|---|---|---|
| | | | of electron beam | | | |
| | | | irradiation and influence depth | | | |
| | | | thereof | | | |
| | | Spray coating | presence or | influence depth | Plasma erosion | |
| No. | Substrate | material | absence | (μm) | depth (μm) | Remarks |
| 1 | SUS 304 | Al₂O₃—Y₂O₃ | absence | — | 0.8-1.0 | Comparative |
| | | composite oxide | | | | Example |
| 2 | | | presence | 3 | 0.2-0.42 | Invention |
| | | | | | | Example |
| 3 | | | presence | 10 | 0.2-0.40 | Invention |
| | | | | | | Example |
| 4 | | SiO₂ | absence | — | 20-25 | Comparative |
| | | | | | | Example |

(Note)
(1) Thickness of Al₂O₃—Y₂O₃ spray coating was 150 μm.
(2) The surface of the spray coating was mirror-polished for the testing.
(3) The erosion depth was measured at three places of the test piece surface and shown by a range of the measured values.

### Example 7

In this example, a one-side surface of a test piece of SUS 304 steel (size: width 50 mm×length 60 mm×thickness 3.2 mm) was subjected to a blast treatment, and thereafter Al₂O₃—Y₂O₃ composite oxide coating was directly formed at a thickness of 150 μm on the surface thereof by an atmospheric plasma spraying method, or an undercoat of 80 mass % Ni-20 mass % Cr alloy was formed at a thickness of 150 μm by an atmospheric plasma spraying and then a top coat of Al₂O₃—Y₂O₃ composite oxide formed on the undercoat at a thickness of 150 μm by an atmospheric plasma spraying method. Thereafter, the surfaces of these Al₂O₃—Y₂O₃ composite oxide spray coatings were subjected to a densification treatment by irradiating electron beams. Moreover, Al₂O₃—Y₂O₃ composite oxide spray coating not irradiated by electron beam was provided as a comparative example and subjected to a thermal shock test under the same conditions to measure occurrence of cracks in the composite oxide spray coating as a top coat and presence or absence of the peeling.

In the thermal shock test, the test piece was placed in an electric furnace adjusted to 500° C. for 15 minutes and then charged into a tap water of 20° C. This operation was one cycle, and repeated in 5 cycles while the appearance state of the top coat was observed in every cycle. The number of the test pieces was three per one condition, and a case that cracks were generated in one test piece is shown by “⅓ crack occurrence”.

Table 6 summarizes the above results. As seen from these results, the spray coating formed on the undercoat above the substrate developed good resistance to thermal shock irrespectively of the presence or absence of the electron beam irradiation and defects such as cracks or the like were not observed on the top coat.

On the contrary, in the Al₂O₃—Y₂O₃ composite oxide spray coatings directly formed on the substrate as a top coat (No. 1 and 2), when electron beams were not irradiated, cracks were generated in two test pieces among three test pieces (shown by ⅔).

On the other hand, in the Al₂O₃—Y₂O₃ composite oxide spray coating irradiated by electron beam (No. 2), micro cracks were merely generated in one test piece among three test pieces, and the resistance to thermal shock was found to be somewhat improved. From these results, it is clear that the densification of the Al₂O₃—Y₂O₃ composite oxide spray coating through the electron beam irradiation were limited to be made in the vicinity of the surface of the coating and that the interior of the coating was maintained at a state of having many pores. Therefore, the acceptable examples for the invention were found to hold strong resisting forces against thermal shock.

TABLE 6

| | | | | Presence or | | Results of | |
|---|---|---|---|---|---|---|---|
| | | | | absence of electron | | thermal shock | |
| | | | | beam irradiation and influence | | test (500° C. × | |
| | | | | depth thereof | | 15 min) [symbol] | |
| | | Spray coating material | | presence or | influence depth | charging into | |
| No. | Substrate | undercoat | top coat | absence | (μm) | water, 5 cycles | Remarks |
| 1 | SUS 304 | absence | Al₂O₃—Y₂O₃ | absence | — | ⅔ crack, | Comparative |
| | | | composite | | | partly peeling | Example |
| 2 | | | oxide | presence | 3 | ⅓ crack | Invention |
| | | | | | | | Example |
| 3 | | presence | | absence | — | no crack and | Comparative |
| | | (80Ni—20Cr) | | | | peeling | Example |
| 4 | | | | presence | 3 | no crack and | Invention |
| | | | | | | peeling | Example |
| 5 | | | | presence | 5 | no crack and | Invention |
| | | | | | | peeling | Example |
| 6 | | | | presence | 8 | no crack and | Invention |
| | | | | | | peeling | Example |

(Note)
(1) Each of undercoat (80Ni—20Cr) and top coat (Al₂O₃—Y₂O₃ composite oxide) are formed at a thickness of 150 μm by an atmospheric plasma spraying method.
(2) Meaning of fractional number in column of “Result of thermal shock test” ⅓ means that crack or peeling is caused in one top coat among three test pieces.

### INDUSTRIAL APPLICABILITY

The technique of the invention could be widely utilized in industrial fields of using spray coatings of Al₂O₃ or Y₂O₃ or Al₂O₃—Y₂O₃ composite oxide. Also, it is preferably used as a protection technique for members in semiconductor working-producing-inspecting apparatus or members in liquid crystal producing apparatus which conduct plasma etching reaction in a gas atmosphere of a halogen or a halogen compound.

1. A spray coating member having an excellent heat emission property and the like, which comprises a substrate and a spray coating of a colored composite oxide made of a low luminosity, achromatic or chromatic Al₂O₃—Y₂O₃ covering the surface of the substrate.

2. A spray coating member having an excellent heat emission property and the like according to claim 1, wherein an undercoat made of a metal/alloy or cermet spray coating is disposed between the surface of the substrate and the spray coating of the colored composite oxide.

3. A spray coating member having an excellent heat emission property and the like according to claim 1, wherein the spray coating of the colored composite oxide has a color formed by decreasing a luminosity inherent to spraying powder material or further decreasing a chromaticity thereof through electron beam irradiating treatment or laser beam irradiating treatment.

4. A spray coating member having an excellent heat emission property and the like according to claim 1, wherein the spray coating of the colored composite oxide has a thickness of 50-2000 μm.

5. A spray coating member having an excellent heat emission property and the like according to claim 2, wherein the undercoat is a metal sprayed coating of 50-500 μm in thickness made from at least one metal or an alloy selected from Ni and an alloy thereof, Mo and an alloy thereof, Ti and an alloy thereof, Al and an alloy thereof and Mg alloy, or a cermet.

6. A method of producing a spray coating member having an excellent heat emission property and the like, which comprises spraying a spraying powder material of Al₂O₃—Y₂O₃ composite oxide having a high luminosity and a white color directly onto a surface of a substrate or onto a surface of an undercoat formed on the surface of the substrate, and then subjecting a surface of the thus sprayed coating of the white-color Al₂O₃—Y₂O₃ composite oxide to electron beam irradiation or laser beam irradiation to change the surface of the spray coating into a low luminosity achromatic or chromatic color.

7. A method of producing a spray coating member having an excellent heat emission property and the like according to claim 6, wherein a layer of less than 50 μm located inward from the surface of the spray coating of the white-color Al₂O₃—Y₂O₃ composite oxide is changed into a low luminosity, achromatic or chromatic color through the electron beam irradiation or the laser beam irradiation.

8. A method of producing a spray coating member having an excellent heat emission property and the like, which comprises plasma-spraying a spraying powder material of Al₂O₃—Y₂O₃ composite oxide having a high luminosity and a white color directly onto a surface of a substrate or onto a surface of an undercoat of a metal spray coating formed on the surface of the substrate to form a colored composite oxide spray coating made of low luminosity, achromatic or chromatic Al₂O₃—Y₂O₃.

9. A method of producing a spray coating member having an excellent heat emission property and the like according to claim 8, wherein the plasma-spraying is carried out in an air or an atmosphere having a partial oxygen pressure lower than that of air.

10. A spray coating member having an excellent heat emission property and the like according to claim 2, wherein the spray coating of the colored composite oxide has a color formed by decreasing a luminosity inherent to spraying powder material or further decreasing a chromaticity thereof through electron beam irradiating treatment or laser beam irradiating treatment.

11. A spray coating member having an excellent heat emission property and the like according to claim 2, wherein the spray coating of the colored composite oxide has a thickness of 50-2000 μm.

12. A spray coating member having an excellent heat emission property and the like according to claim 3, wherein the spray coating of the colored composite oxide has a thickness of 50-2000 μm.

13. A spray coating member having an excellent heat emission property and the like according to claim 10, wherein the spray coating of the colored composite oxide has a thickness of 50-2000 μm.
